(19) United States
(12) Patent Application Publication
(10) Pub. No.: US 2008/0281887 A1
(43) Pub. Date: Nov. 13, 2008

(54) Application specific garbage collection system

(75) Inventor: Juha Uola, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/801,617

(22) Filed: May 10, 2007

(51) Int. Cl. G06F 12/02

(52) U.S. Cl. 707/206; 707/E17.005

(57) ABSTRACT

On a platform or virtual machine, a system and method is provided that allows an application to implement its own Garbage Collection (GC) utility that can be designed and tuned for the specific application. The GC utility can be bundled with the application, and can be installed on the platform as necessary along with the application. When the application is activated, the specific GC utility is also activated. Such specific GC utility can provide improvements in performance. The present invention may be used on any type of platform, such as a Java platform, and any type of hardware such as mobile devices.

### FIELD OF THE INVENTION

This invention relates generally to memory management, and more particularly to software applications with garbage collection utilities.

### BACKGROUND OF THE INVENTION

Languages, such as Lisp, Java, C# and Ada, are based on dynamic resource management utilizing a garbage collection system. Garbage collection (GC) takes care of freeing dynamically allocated memory that is no longer referenced. Because the objects in the Java heap are garbage collected, Java programmers don't have to explicitly free allocated memory. Garbage collection has also been implemented in other languages, such as C and C++.

Garbage collection is implemented as a part of a managed runtime platform, such as the Java virtual machine (VM). Restricted embedded devices, such as mobile terminals, need to have an optimized runtime platform, especially in terms of their memory footprint. This means that a simple garbage collection utility is usually implemented in a mobile terminal Java VM.

Java Mobile Device Profile (MIDP) is the most widely adopted application platform in mobile terminals currently. More advanced and feature-rich platforms are being developed and standardized, allowing more advanced and more complex applications to be run on top the Java platforms. Several different Java VM implementations from different vendors are in use. A specific GC algorithm is not standardized in the Java specifications; it is left to the Java VM vendor to decide what kind of GC algorithm or utility to use.

Even though a generic GC utility is sufficient for most applications, some applications would greatly benefit from a more specific or customized GC utility. Applications may have performance characteristics that result in long noticeable garbage collection pauses, which can cause the user perception of the application to degrade. It may be necessary to completely redesign an application because of an unsuitable GC utility on a particular platform, which increases development costs. Further, each application platform implementation may have its own GC utility, which makes it unfeasible to target one GC utility in application design.

Thus there is a need for a GC utility that can better fit the requirements of a particular application.

### SUMMARY OF THE INVENTION

Certain embodiments of the present invention include a system and method that allows an application to implement its own Garbage Collection (GC) utility that can be designed and tuned for the specific application. The GC utility can be bundled with the application, and can be installed on a platform or virtual machine as necessary along with the application. When the application is activated, the specific GC utility is also activated. Such specific GC utility can provide improvements in performance. The present invention may be used on any type of platform, such as a Java platform, and any type of hardware such as mobile devices.

In certain embodiments of the present invention, a software application can use a GC utility with a suitable and optimized GC algorithm, which can improve performance.

Another advantage is that a platform (such as a Java platform) need not store many GC utilities in order to achieve application adaptation. This saves storage memory, which may be limited, such as with flash memory.

Another advantage of certain embodiments of the present invention is more adaptability to a Java platform and improved performance.

An embodiment of the present invention includes steps of activating an application, determining whether a specific garbage collection (GC) utility is installed for the activated application, and if the specific GC utility is installed, activating the specific GC utility along with the application. These steps may include utilizing the specific GC utility to perform memory garbage collection for the application. An embodiment may include accessing the specific GC utility through a GC invocation API (application program interface), wherein the GC invocation API allows standardized access to any one of a plurality of GC utilities. Further, the specific GC utility may perform memory garbage collection utilizing a memory manager API (application program interface), wherein the memory manager API allows standardized access by any one of a plurality of GC utilities to memory functionality.

The specific GC utility may be designed to perform memory garbage collection efficiently for the application. This may include a feature that the specific GC utility includes information regarding at least one class of objects utilized by the application.

This information may allow the specific GC utility to more efficiently perform GC operations.

An embodiment may include steps of receiving the application for installation, the application including the specific GC utility to be used by the application, and installing the specific GC utility so as to allow the specific GC utility to be used by the application. It may also include a step of providing a pluggable interface, wherein the specific GC utility uses the pluggable GC interface when the specific GC utility is used by the application. If the specific GC utility is not installed an embodiment may activate a basic GC utility available for applications, to perform memory garbage collection for the application. The GC utility may be installed on a Java virtual machine, or any type of platform.

Another embodiment of the present invention includes a first application to be installed on a platform for execution, wherein the platform includes a default GC utility to perform memory garbage collection for applications executing on the platform. The first application includes an indication to indicate to the platform that when the first application is executing on the platform, a specific GC utility, that is different from the default GC utility, should be used to perform memory garbage collection for the first application. The first application and the specific GC utility may be included in an application distribution package, and when the first application is installed on the platform for execution, the specific GC utility is also installed on the platform. The platform may include an application GC selector, the application GC selector responsive to the indication to select the specific GC utility when the first application executes. Such specific GC utility and default GC utility may perform memory garbage collection utilizing a memory manager API, which allows standardized access by any one of a plurality of GC utilities to memory functionality.

An embodiment may be used on any type of device, including a mobile device. It may be utilized on any device or apparatus, including an apparatus with a processor and memory coupled to the processor, wherein instructions stored in the memory or on computer readable medium will implement the embodiment.

### BRIEF DESCRIPTION OF THE DRAWINGS

FIG. 1 shows an application with an attached GC utility in accordance with an embodiment of the present invention;

FIG. 2 shows the application of FIG. 1 using the installed GC utility during run time;

FIG. 3 shows details of an application on a Java VM system according to one embodiment;

FIG. 4 is a flow diagram of steps performed by an embodiment of the present invention;

FIG. 5 shows a block diagram of components of a system for utilizing an embodiment of the present invention.

### DETAILED DESCRIPTION OF THE INVENTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

Embodiments of the present invention provide a platform that allows an application to implement its own Garbage Collection (GC) utility that can be designed and tuned for the specific application. The GC utility is bundled with the application, which means that the GC utility does not have to be stored permanently and in advance in the Java platform. The GC utility can be removed when the application is removed.

In accordance with one embodiment of the present invention, the platform for the application supports dynamically installable GC utilities. When the application is run, the platform will select the GC utility that was installed with the application to be used with the application.

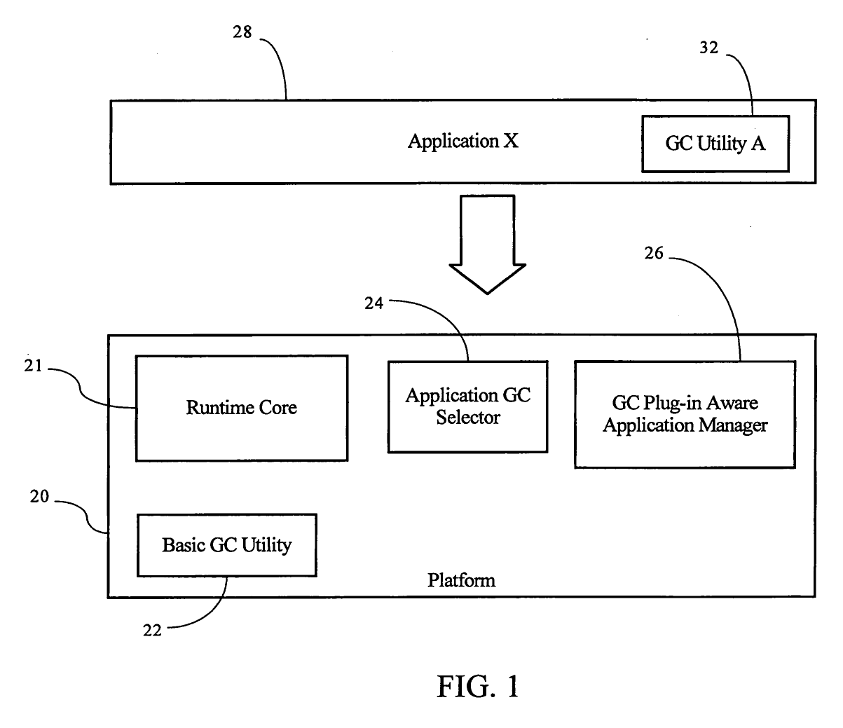

Such an embodiment is illustrated in FIG. 1. A platform 20 provides the run-time environment for an application 28. In this illustrative embodiment, the platform 20 may be a Java virtual machine, or any type of run-time platform or operating system that supports applications. The platform 20 typically includes a basic GC utility 22, which is the default GC utility for the platform 20.

The platform 20 includes a runtime core 21 that uses a GC utility during runtime. The runtime core 21 selects the GC utility for use by an application 28 by querying an application GC selector 24. Alternatively, the application GC selector 24 is not used, and an application 28 is responsible for selecting what GC utility is to be used.

The platform 20 also includes an application manager 26 that is able to detect applications having a GC utility, install such GC utility on platform 20 (for example, during application installation), and remove GC utilities from the platform 20 (for example, during application removal

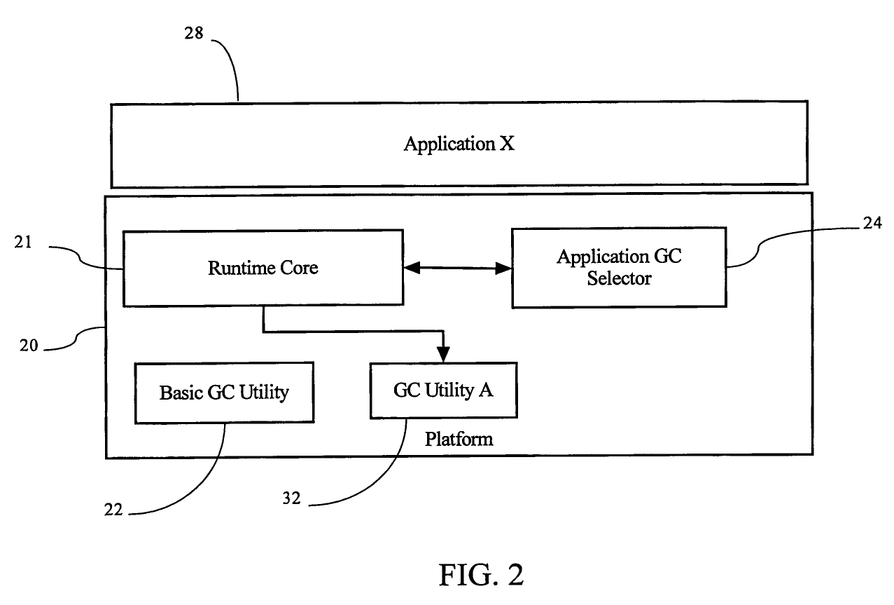

During installation of the application 28 on the platform 20, the specific GC utility 32 is also installed on the platform 20. FIG. 2 shows the platform 20 during run time. When the application 28 is activated, the runtime core 21 selects the specific GC utility 32 to be used, by using the application GC selector 24. The GC utility 32 implements the GC Invocation API, and this API is used by the runtime core 21 to perform required GC operations when running the application 28. If the platform 20 does not support such pluggable GC utilities, the standard GC utility 22 will be used.

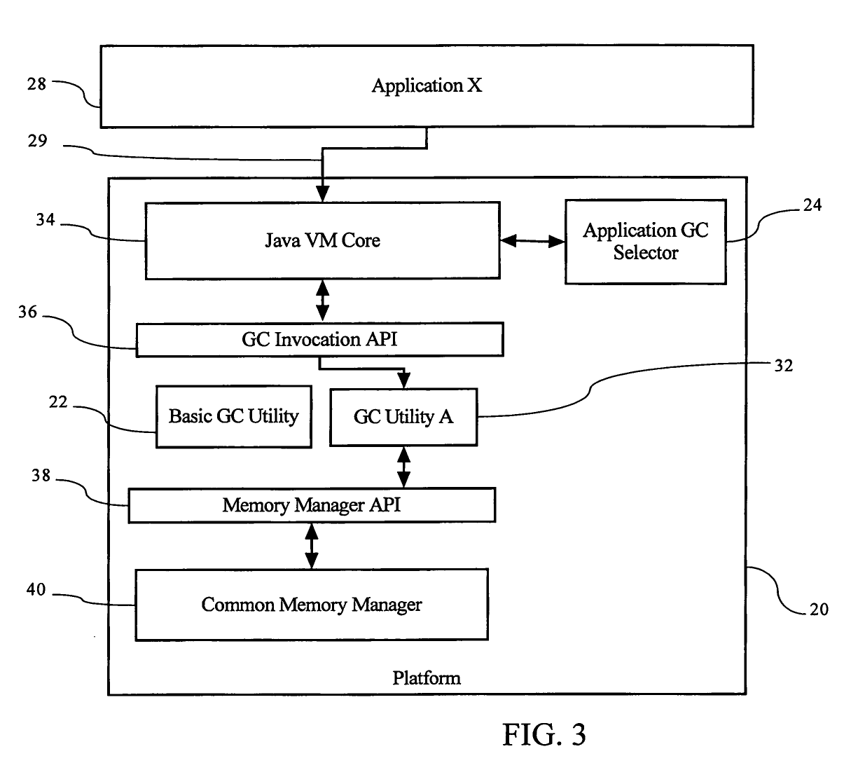

FIG. 3 illustrates an embodiment running on a Java platform. After a GC utility 32 is installed and ready to be used, it typically interacts with the rest of the platform 20 using two APIs (application program interfaces). The first API 36 may be considered to be a GC Invocation API. This API 36 is used by the platform 20 to call the GC utility 32. The second API 38 may be considered to be a Memory Manager API, and is provided by the platform 20 and used by the GC utility 32 to perform common memory management operations in the system. These are common operations that allow any GC utility 22, 32 to perform its functions.

According to this embodiment, the selected GC utility 22, 32 typically helps implement the certain features in the GC Invocation API 36. These features may include:

| Call | Function |
|---|---|
| bool initializeHeap(int heapSize) | Allocate and initialize heap |
| Object *allocObject(int objectSize) | Allocate a new object |
| void doGC(int tryToFreeThisMuch) | Perform the actual garbage |
| | collection (which, will be called |
| | when all threads are in “GC-safe |
| | points” (execution points that |
| | leave the heap into consistent |
| | state)) |
| bool freeHeap( ) | Free the heap and release other |
| | related resources |

Other features can also be provided depending on the platform. Typically both the GC Invocation API 36 and the Memory Manager API 38 are platform-specific and depend on the Java VM implementation.

As an example for this embodiment, the Application 28 may request a new object by sending a request to create a new object to the VM Core 34, as shown by arrow 29. The VM Core 35 may check with the Application GC Selector 24, to determine if the application 28 has an application-specific GC utility. This result may be cached to avoid multiple calls to the application GC selector 24 for the same application. The VM core 34 may then issue an allocObject call to the specific GC utility 35, using the GC invocation API 22. The specific GC utility may perform some internal bookkeeping for the allocated object or memory (for example, performing reference counting for the object, or determining where in memory to allocate the object), and then make requests to the common memory manager as necessary to allocate memory for the new object.

The common operations that may be offered by the platform 30 in the Memory Manager API 38 for this embodiment are:

| Call | Function |
|---|---|
| stopAllThreadsAndIssueDoGCCallback | Stop all threads in the system to |
| (int tryToFreeThisMuch) | “GC-safe points” (execution |
| | points that leave the heap into |
| | consistent state) |
| Object* [ ] findRoots( ) | Find the objects in the heap |
| | that are considered “roots” |
| | (objects that are used as starting |
| | points when finding all the live |
| | objects in the heap) |
| int getObjectSize(Object *obj) | Query the size of a specific |
| | object in the heap |
| Class* getObjectClass(Object *obj) | Query the class of a specific |
| | object in the heap |
| void setObjectMark(bool mark, | Mark a specific object in the |
| Object *obj) | heap (for reclamation, or marked |
| | for other purposes) |
| bool getObjectMark(Object *obj) | Query whether a specific object |
| | has been marked |

According to this embodiment, the memory need not be contiguous for the GC utility 32. The Memory Manager API 38 can manage the memory appropriately so the GC utility 32 does not need to be concerned with non-contiguous memory segments for the application 28. If it would be helpful (e.g. due to performance reasons) the lower level memory architecture can be exposed to GC utility 32 by the Memory Manager API 38.

An application 28 may be installed on the platform 20. The application 28 may be any type of software application, program, utility, or other system that runs on the platform 20. In this embodiment the application 28 includes its specific GC utility 32. In one embodiment, the GC utility 32 is a separate file in the application distribution package. A GC utility 32 may typically be implemented in the same language as the platform 20. In case of Symbian, for example, the Java VM is implemented in C++ using several DLLs for various VM features. The default GC implementation 22 is in one of DLLs. The pluggable GC utility 32 that comes with the application 28 can be a DLL file that is installed into the platform 20.

The GC utility 32 may be designed and optimized for the application 28. For example, many mobile applications 28 (such as games) suffer from unsuitable GC utilities, with problems including visible UI (User Interface) distortions because of GC pauses. If application 28 is a real time game that can not tolerate long pauses for garbage collection, the GC utility 32 may include an ephemeral (generational) algorithm with memory partitioned into multiple small spaces, and with very quick copy operations to clean out the small memory spaces used by the application 28. Alternatively, if the application 28 is a game that can tolerate long pauses (such as when waiting for a user to provide input), the GC utility 32 may include larger memory partitions that can have the live objects copied out in a longer (but less frequent) garbage collection.

Another GC utility 32 may be tuned to the application 28 in that the application 28 is able to re-create memory objects very quickly, so the GC utility 32 can free up memory by simply reclaiming all memory objects in a very fast operation, and then the application 28 may re-create memory objects as necessary.

Still another GC utility 32 may work to maintain a pool of objects of a certain type that are reused by the application 20 instead of being de-allocated from memory when the object is no longer referenced. The GC utility may maintain a list of such objects that are no longer used, and when a call is received for a new object of that type, the GC utility 32 will return an existing object from the list and remove the object from that list. The maximum number of objects stored on the list may be tuned statically or dynamically to achieve an efficient balance of memory use and processing overhead.

An important issue in GC algorithms is the lifetime of the objects. Default GC algorithms and utilities rely on application average characteristics regarding what is the lifetime of an object. Most modern generational GC algorithms rely on two principles:

Most newly created objects die soon.

Old objects tend to live forever.

If an object survives several GC rounds, it is moved to “old space” that is rarely collected (and this is very expensive). If, for example, application characteristics are such that it creates a lot of mid-length lifetime objects (for this example, we refer to them as instances of class A), the default approach creates long GC delays. Objects are moved to old space, but then need to be collected shortly thereafter. A suitable GC utility for this application would be one that identifies object instances of class A (using Class* getObjectClass (Object *obj)) during the GC and treats those differently than other objects. Depending on the GC utility implementation, such Class A objects can for example not get moved to the old space. Thus various embodiments of the invention allow tailoring of GC algorithms and utilities for specific object types. Knowledge of the lifetime characteristics of certain object type can thus be used to improve the GC performance.

As another example, generational GC algorithms typically rely on a memory heap structure that includes “new space” and “old space” area. The size of these areas is fixed, which means that when one area fills up, the application execution ends with an “out of memory error” even though there may be space in the other area. An application may wish to optimize for memory usage (perhaps at the cost of performance) and provide a plug-in GC utility that is based on just one memory area (for example a “mark and sweep algorithm” or a “compact in place” algorithm, etc.). All memory in this area can be fully utilized by the application. This way the application is able to execute on a platform that would have too little memory using the default generational GC algorithm and related heap structure.

Application object lifetime characteristics are typically not associated to any particular application type. Even simple applications can create a lot of objects and their characteristics can differ from the average. Thus, the present invention provides an ability to customize the GC utility for a specific application.

The GC utility 32 may be implemented in any language, including in native C/C++ language, even though the application 28 may be implemented in e.g. Java. The GC utility 32 may be e.g. a DLL (dynamic link library).

In another embodiment, in addition to the two APIs previously described (the GC invocation API 36 and the Memory Manager API 38, FIG. 3), a third interface may be defined, such as a GC plug-in management interface (not shown). This interface would be provided by a GC plug-in-capable Java VM, and would be used to install, remove and query GC utility plug-ins. The interface is typically used by the platform application management component when installing and removing an application. Such an interface would typically not be used when an application is executing.

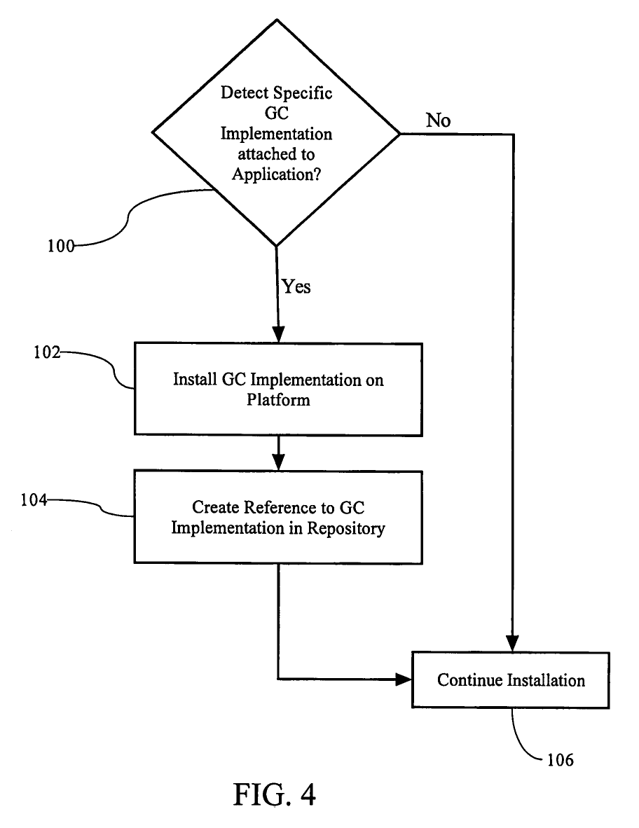

FIG. 4 shows the steps performed during an application installation, in accordance with one embodiment. During the installation of the application, the platform detects whether a specific GC utility is attached to, or provided with, the application, step 100. One method of detection is to search for an entry in the application descriptor file that is typically present in all current Java applications. If a GC utility is not provided, the installation process continues on, step 106. If there is an attached GC utility, it is installed on the platform, step 102. The GC utility is typically a library that needs to be located by the platform when it is to be used. The GC utility library is most likely installed to a specific location, from where a Java VM implementation expects to be able to load it (on Linux, for example, LD_LIBRARY_PATH). Next, the reference to the GC utility is added to a repository inside the application GC selector 24 indicating that the application preferred GC algorithm when application is installed, step 104. This allows the platform 20 to use the correct GC utility for applications at run time. The installation process then continues on, step 106.

If the application is uninstalled from the platform, the GC utility may be uninstalled with the application. However, if the GC utility is used by more than one application, the platform may skip removing the GC utility. Further, some implementations may decide to delay uninstallation of the GC utility until storage memory is about to run out. If a particular GC utility is already installed when an application with the same GC utility is installed, it is then possible to skip installation of the particular GC utility.

In an alternative invention implementation, the GC utility that comes with the application may be in a form other than binary code. For example the GC utility may be a set of parameters to tune or optimize a standard GC utility. Alternatively it may be a script or formal description that the platform may interpret and implement. In this case the platform may include a particular parsing component that is able to handle the GC algorithm description. The platform GC system may be completely adaptive, allowing the GC algorithm description to largely define the behaviour of the GC

An embodiment of the present invention can work on a platform with multiple applications running in parallel. Typically all applications share the same heap that is managed by one GC utility. A problem may occur if parallel applications use different GC algorithms. This embodiment may separate heap areas for applications that define their own GC utility. Alternatively, if an application defines its own GC utility, then that GC utility is used for all running applications.

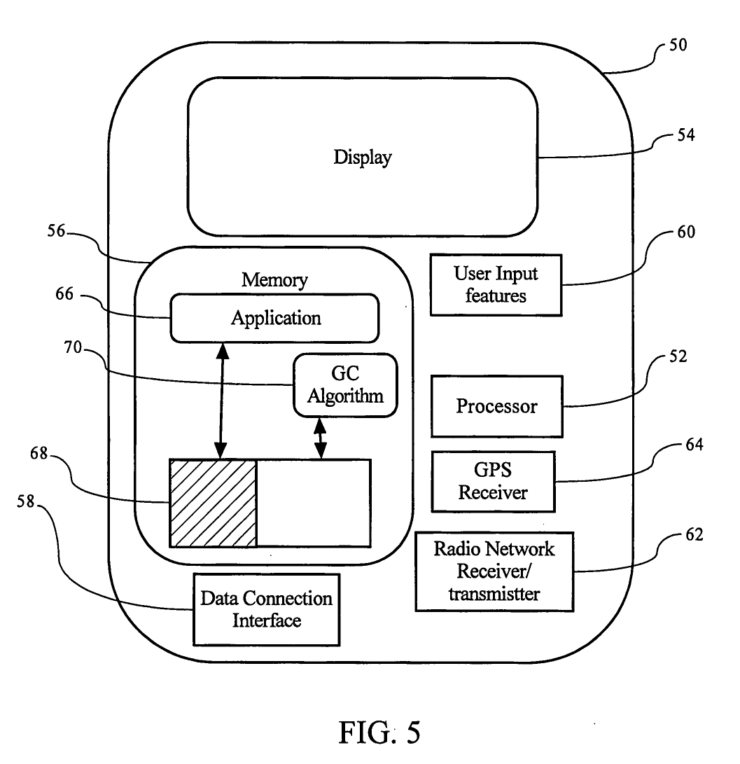

A system for implementing an embodiment of the present invention is shown in FIG. 5 with reference to a mobile device 50. Mobile device 50 may comprise a network-enabled wireless device, such as a digital camera, a cellular phone, a mobile terminal, a data terminal, a pager, a laptop computer or combinations thereof. The mobile device may also comprise a device that is not network-enabled, such as a personal digital assistant (PDA), a wristwatch, a GPS receiver, a portable navigation device, a car navigation device, a portable TV device, a portable video device, a portable audio device, or combinations thereof. Such non network-enabled devices may include RFID tag readers. Further, the mobile device may comprise any combination of network-enabled wireless devices and non network-enabled devices. Although device 50 is shown as a mobile device, it is understood that the invention may be practiced using non-portable or non-movable devices. As a network-enabled device, mobile device 50 may communicate over a radio link to a wireless network (not shown) and through gateways and web servers. Examples of wireless networks include third-generation (3G) cellular data communications networks, Global System for Mobile communications networks (GSM), WLAN networks, or other wireless communication networks. Mobile device 50 may also communicate with a web server one or more ports (not shown) on the mobile device that may allow a wired connection to the Internet, such as universal serial bus (USB) connection, and/or via a short-range wireless connection (not shown), such as a BLUETOOTH™ link or a wireless connection to WLAN access point. Thus, mobile device 50 may be able to communicate with a web server in multiple ways.

As shown in FIG. 5, the mobile device 50 may include a processor 52, a display 54, memory 56, a data connection interface 58, and user input features 60, such as keypads, touch screens etc. It may also include a short-range radio transmitter/receiver 62, a global positioning system (GPS) receiver 64 and possibly other sensors (not shown). The processor 52 is in communication with memory 56 and performs instructions stored therein. The processor 52 is connected to display 54 and generates a display thereon, such as maps other displays. The user input features 60 are also in communication with the processor 52 for providing inputs to the processor. In combination, the user input 60, display 54 and processor 52, in concert with instructions stored in memory 56, generally form a graphical user interface (GUI), which allows a user to interact with the device and modify displays shown on display 54. Data connection interface 58 is connected to processor 52 and enables communication with wireless networks as previously described.

Short-range radio transmitter/receiver 62 is connected to processor 52 and enables communication via short-range radio communications, such as communications via a BLUETOOTH™ link or communications with radio frequency identification (RFID) tags. GPS receiver 64 receives GPS transmissions and communicates with processor 52 to enable the processor to determine current location information for mobile device 50. Mobile device 50 may also take advantage of other positioning mechanisms, such as positioning methods based on communication signals between the mobile device and base stations (e.g., triangulation methods) and proximity based methods (e.g., communication with a BLUETOOTH proximity sensor). Other sensors may be included in mobile device 50, such as accelerometers, cameras, thermometers, microphones, compass, etc. that can provide context information for the mobile device. For instance, accelerometers or a compass within mobile device 50 may provide information in concert with GPS receiver 64 to assist with providing real-time map updates to the user based on user movements along a route. Overall, mobile device 50 is generally a mobile computing device, such as a handheld personal computer, a mobile communication device, and a mobile terminal, that may include a variety of internal components, communication hardware and software, attachments, and the like.

In accordance with instructions in memory 56, the processor performs steps for providing a platform to allow applications to run, such as on a virtual machine. When the application 66 is run, it is typically partially or fully loaded into the memory 56. The application 66 typically uses some allocated memory 68 for its processing. Such memory 68 may be pre-allocated to the application 66 upon activation, or the memory 68 may be provided in varying amounts upon requests from the application 66. For GC purposes, it may be preferable to have a contiguous section of allocated memory 68; however a GC Utility may be optimized to work with non-contiguous memory areas, in accordance with an embodiment of the present invention. A GC utility 70 may be activated with the application 66, the GC utility 70 also having access to the memory 68, in order to perform storage management and reclamation. As previously described, this application specific GC utility 70 can provide a much improved garbage collection, and greatly improve the functioning of both the application 66 and the mobile device 50.

Additionally, the methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

I/We claim:

1. A method comprising:
activating an application;
determining whether a specific garbage collection (GC) utility is installed for said activated application;
if said specific GC utility is installed, activating said specific GC utility along with said application; and
utilizing said specific GC utility to perform memory garbage collection for said application.

2. The method of claim 1 further including:
accessing said specific GC utility through a GC invocation API (application program interface), wherein said GC invocation API allows standardized access to any one of a plurality of GC utilities.

3. The method of claim 1, wherein said specific GC utility performs memory garbage collection utilizing a memory manager API (application program interface), wherein said memory manager API allows standardized access by any one of a plurality of GC utilities to memory functionality.

4. The method of claim 1 wherein said specific GC utility is designed to perform memory garbage collection efficiently for said application.

5. The method of claim 4 wherein said specific GC utility includes information regarding at least one class of objects utilized by said application.

6. The method of claim 1 further including:
receiving said application for installation, said application including said specific GC utility to be used by said application; and
installing said specific GC utility so as to allow said specific GC utility to be used by said application.

7. The method of claim 6 further including:
providing a pluggable interface, wherein said specific GC utility uses said pluggable GC interface when said specific GC utility is used by said application.

8. The method of claim 1 wherein said GC utility is installed on a Java virtual machine.

9. The method of claim 1 further including:
if said specific GC utility is not installed, activating a basic GC utility available for applications, to perform memory garbage collection for said application.

10. The method of claim 1 wherein said method is implemented on a mobile device.

11. Apparatus comprising:
a processor;
a memory, coupled to said processor, said memory including instructions, that, when provided to said processor cause said processor to carry out steps of:
activating an application;
determining whether a specific GC utility is installed for said activated application;
if said specific GC utility is installed, activating said specific GC utility along with said application; and
utilizing said specific GC utility to perform memory garbage collection for said application.

12. The apparatus of claim 11 wherein said step of utilizing said specific GC utility includes accessing said specific GC utility through a GC invocation API (application program interface), wherein said GC invocation API allows standardized access to any one of a plurality of GC utilities.

13. The apparatus of claim 11, wherein said specific GC utility performs memory garbage collection utilizing a memory manager API (application program interface), wherein said memory manager API allows standardized access by any one of a plurality of GC utilities to memory functionality.

14. The apparatus of claim 11 wherein said specific GC utility is designed to perform memory garbage collection efficiently for said application.

15. The apparatus of claim 14 wherein said specific GC utility includes information regarding at least one class of objects utilized by said application.

16. The apparatus of claim 11, wherein said application includes said specific GC utility, and when said application is installed in said apparatus, said specific GC utility is also installed.

17. The apparatus of claim 16 further including:
a pluggable interface for a GC utility, wherein said installed specific GC utility uses said pluggable GC interface when said specific GC utility is used by said application.

18. The apparatus of claim 11 wherein said specific GC utility is installed on a Java virtual machine.

19. The apparatus of claim 1 1 wherein said apparatus is a mobile device.

20. A machine-readable medium having machine-executable instructions for performing steps comprising:
installing an application, said application including a specific GC utility to be used by said application;
installing said specific GC utility;
wherein when said application is activated, said specific GC utility is also activated through a pluggable GC interface, so as to allow said specific GC utility to perform memory garbage collection for said application.

21. The machine-readable medium of claim 20 wherein said steps further include:
accessing said specific GC utility through a GC invocation API (application program interface), wherein said GC invocation API allows standardized access to any one of a plurality of GC utilities.

22. The machine-readable medium of claim 20 wherein said specific GC utility performs memory garbage collection utilizing a memory manager API (application program interface), wherein said memory manager API allows standardized access by any one of a plurality of GC utilities to memory functionality.

23. The machine-readable medium of claim 20 wherein said specific GC utility is designed to perform memory garbage collection efficiently for said application.

24. The machine-readable medium of claim 23 wherein said specific GC utility includes information regarding at least one class of objects utilized by said application.

25. A system comprising:
a first application, said first application to be installed on a platform for execution, wherein said platform includes a default GC utility to perform memory garbage collection for applications executing on said platform;
wherein said first application includes an indication to indicate to said platform that when said first application is executing on said platform, a specific GC utility, that is different from said default GC utility, should be used to perform memory garbage collection for said first application.

26. The system of claim 25, wherein said first application and said specific GC utility are included in an application distribution package, and wherein when said first application is installed on said platform for execution, said specific GC utility is also installed on said platform.

27. The system of claim 25, wherein said platform includes an application GC selector, said application GC selector responsive to said indication to select said specific GC utility when said first application executes.

28. The system of claim 25, wherein said specific GC utility includes information regarding at least one class of objects utilized by said application.

29. The system of claim 25, wherein said specific GC utility and said default GC utility perform memory garbage collection utilizing a memory manager API, said memory manager API allowing standardized access by any one of a plurality of GC utilities to memory functionality.

30. A mobile device comprising:
a display component;
a processing component, coupled to said display component;
a memory component, coupled to said processing component;
wherein said memory component includes instructions, that when provided to said processing component, cause said processing component to perform the steps of:
receiving an application for installation, said application including a specific GC utility to be used by said application;
installing said application;
installing said specific GC utility;
activating said application;
determining whether said specific GC utility is installed for said activated application;
if said specific GC utility is installed, activating said specific GC utility along with said application; and
utilizing said specific GC utility to perform memory garbage collection for said application;
wherein said specific GC utility is designed to perform memory garbage collection efficiently for said application.
